(19) United States
(12) Patent Application Publication
(10) Pub. No.: US 2025/0159312 A1
(43) Pub. Date: May 15, 2025

(54) VIDEO GENERATION METHOD AND APPARATUS, MEDIUM, AND ELECTRONIC DEVICE

(71) Applicant: Douyin Vision Co., Ltd., Shijingshan District (CN)

(72) Inventors: Yihao LIU, Beijing (CN); Chenchi LIANG, Beijing (CN); Lei WAN, Beijing (CN)

(21) Appl. No.: 18/916,501

(22) Filed: Oct. 15, 2024

(30) Foreign Application Priority Data
Nov. 10, 2023 (CN) 202311499340.9

(51) Int. Cl. H04N 21/81; G06V 30/148; G06V 30/18; H04N 21/488

(52) U.S. Cl. CPC H04N 21/816; G06V 30/153; G06V 30/18; H04N 21/4884

(57) ABSTRACT

The present disclosure relates to a video generation method and apparatus, a medium, and an electronic device. The method includes: splitting a target text to obtain a plurality of sub-texts corresponding to the target text; performing character feature extraction on the target text to obtain a character feature of each character in the target text; determining a plurality of text content features respectively corresponding to the plurality of sub-texts, where a text content feature corresponding to each sub-text is used to represent content described in the sub-text; respectively determining a target feature corresponding to each sub-text based on the character feature and a text content feature corresponding to each sub-text; generating a text image corresponding to each sub-text based on the target feature; and generating a target video corresponding to the target text based on the plurality of sub-texts and text images corresponding to the plurality of sub-texts.

### CROSS-REFERENCE TO RELATED APPLICATION

This application claims the priority to and benefits of Chinese Patent Application No. 202311499340.9, filed on Nov. 10, 2023. All the aforementioned patent application is hereby incorporated by reference in its entirety.

### TECHNICAL FIELD

The present disclosure relates to the field of computer technologies, and specifically, to a video generation method and apparatus, a medium, and an electronic device.

### BACKGROUND

In some cases, in a process of generating a video based on text, in order to improve image generation efficiency, a picture is usually generated for each sentence in a piece of text, and then the generated pictures are spliced to form a video, so as to achieve an effect of generating the video based on the text. However, in the above solution, individual frames in the video are generated separately, which may cause the generated video to have a problem of sudden frame change when switching the frames in the generated video.

### SUMMARY

This section of Summary is provided to briefly introduce the invention concepts of the present disclosure, and these invention concepts will be described in detail in the section of Detailed Description of the present disclosure below. The section of Summary is not intended to identify key features or necessary features of the claimed technical solutions, nor is it intended to be used to limit the scope of the claimed technical solutions.

The present disclosure provides a video generation method, and the method comprises: splitting a target text to obtain a plurality of sub-texts corresponding to the target text; performing character feature extraction on the target text to obtain a character feature of each character in the target text; determining a plurality of text content features respectively corresponding to the plurality of sub-texts, a text content feature corresponding to a sub-text of the plurality of sub-texts is used to represent content described in the sub-text; respectively determining a target feature corresponding to each sub-text of the plurality of sub-texts based on the character feature and a text content feature corresponding to the each sub-text; generating a text image corresponding to the each sub-text based on the target feature; and generating a target video corresponding to the target text based on the plurality of sub-texts and text images corresponding to the plurality of sub-texts, respectively.

The present disclosure provides a video generation apparatus, and the apparatus comprises: a processing module, configured to split a target text to obtain a plurality of sub-texts corresponding to the target text; an extraction module, configured to perform character feature extraction on the target text to obtain a character feature of each character in the target text; a first determination module, configured to determine a plurality of text content features respectively corresponding to the plurality of sub-texts, where a text content feature corresponding to a sub-text of the plurality of sub-texts is used to represent content described in the sub-text; a second determination module configured to, respectively determine a target feature corresponding to each sub-text of the plurality of sub-texts based on the character feature and a text content feature corresponding to the each sub-text; a first generation module, configured to generate a text image corresponding to the each sub-text based on the target feature; and a second generation module, configured to generate a target video corresponding to the target text based on the plurality of sub-texts and text images corresponding to the plurality of sub-texts, respectively.

The present disclosure provides a non-transitory computer-readable medium having a computer program stored thereon, when the computer program is executed by a processor, the steps of the video generation method according to any embodiment of the present disclosure are implemented.

The present disclosure provides an electronic device, comprising: a memory having a computer program stored thereon; and a processor configured to execute the computer program in the memory to implement the steps of the video generation method according to any embodiment of the present disclosure.

Other features and advantages of the present disclosure will be described in detail in the section of Detailed Description of the present disclosure below.

### BRIEF DESCRIPTION OF DRAWINGS

The above and other features, advantages, and aspects of each embodiment of the present disclosure may become more apparent with reference to the following specific embodiments and in conjunction with the accompanying drawings. Throughout the drawings, the same or similar reference numerals denote the same or similar elements. It should be understood that the accompanying drawings are schematic and that parts and elements are not necessarily drawn to scale. In the drawings:

FIG. 1 is a flowchart of a video generation method according to an embodiment of the present disclosure;

FIG. 2 is a block diagram of a video generation apparatus according to an embodiment of the present disclosure; and

FIG. 3 illustrates a schematic diagram of a structure of an electronic device suitable for implementing embodiments of the present disclosure.

### DETAILED DESCRIPTION

Embodiments of the present disclosure are described in more detail below with reference to the accompanying drawings. Although some embodiments of the present disclosure are shown in the drawings, it should be understood that the present disclosure may be implemented in various forms and should not be construed as being limited to the embodiments set forth herein. On the contrary, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. In addition, additional steps may be included and/or the execution of the illustrated steps may be omitted in the method implementations. The scope of the present disclosure is not limited in this respect.

The term “include/comprise” and the variations thereof used herein are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not intended to limit the sequence of functions performed by these apparatuses, modules, or units or interdependence of these apparatuses, modules, or units.

It should be noted that the modifiers “one” and “a plurality of/more” mentioned in the present disclosure are illustrative and not restrictive, and those skilled in the art should understand that unless the context clearly indicates otherwise, the modifiers should be understood as “one or more”.

Names of messages or information interacted between a plurality of apparatuses in the implementations of the present disclosure are used for illustrative purposes only, and are not used to limit the scope of these messages or information.

It may be understood that before the technical solutions disclosed in the embodiments of the present disclosure are used, the types, scope of use, use scenarios, and the like of personal information involved in the present disclosure should be informed to users and the users' authorization should be obtained in an appropriate manner in accordance with relevant laws and regulations.

For example, a prompt message is sent to a user in response to receiving an active request from the user, to clearly prompt the user that the operation requested by the user will need to obtain and use the user's personal information. Therefore, the user can independently choose whether to provide personal information to a software or hardware such as an electronic device, an application, a server, or a storage medium that executes the operation of the technical solution of the present disclosure according to the prompt message.

As an optional but non-limiting implementation, in response to receiving an active request from a user, the prompt message may be sent to the user in a pop-up window, and the prompt message may be presented in text in the pop-up window. In addition, the pop-up window may also carry a selection control for the user to choose “agree” or “disagree” to provide personal information to the electronic device.

It may be understood that the above notification and the process for obtaining user authorization are only schematic and does not limit the implementation of the present disclosure. Other methods that meet relevant laws and regulations may also be applied to the implementation of the present disclosure.

In addition, it may be understood that the data involved in the technical solutions (including but not limited to the data itself, the acquisition or use of the data) should comply with the requirements of corresponding laws, regulations, and relevant provisions.

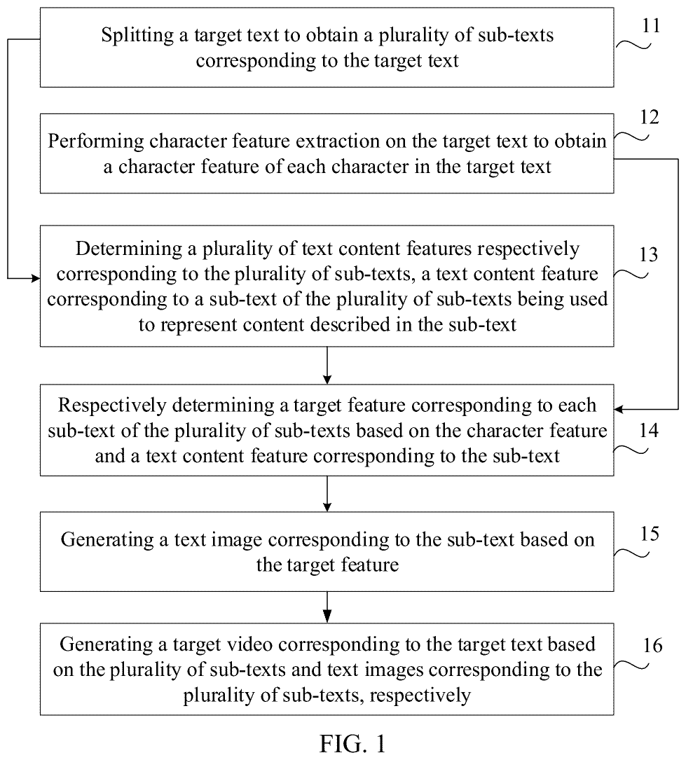

FIG. 1 is a flowchart of a video generation method according to an embodiment of the present disclosure. As shown in FIG. 1, the method may include:

In step 11, splitting a target text to obtain a plurality of sub-texts corresponding to the target text.

The target text may be a text input by a user for generating a video, or may be a text received from another interface, such as a novel text received from a novel reader. As an example, each sentence in the target text may be split into one sub-text.

As another example, in various video fields, such as movies, animations, TV series, advertisements, and music videos, a storyboard may be used to illustrate the composition of images in a chart form before actual shooting or drawing, and continuous images are decomposed by taking unit of one shot, and the shot mode, duration, dialogue, effect, and the like are marked. In the embodiments of the present disclosure, the sub-text may also be a text corresponding to one storyboard. Contents in different sub-texts are different, and contents described in the same sub-text are similar, thereby ensuring the consistency and continuity of contents in the final video when the final video is generated based on the sub-texts.

In step 12, performing character feature extraction on the target text to obtain a character feature of each character in the target text.

The character may be used to represent all character images in the target text. In this step, feature extraction may be performed on the target text as a whole, so that the diversity of the extracted characters and the global representation of the character features can be ensured, thereby facilitating the feature description of each character in the target text and providing constraints in the character dimension for subsequent image generation for each sub-text.

As an example, feature extraction may be performed by using a character extraction model. The character extraction model may be implemented by using an NLP (Natural Language Processing) model, and may be trained by using a general training method in the art, which will not be described in detail here.

In step 13, determining a plurality of text content features respectively corresponding to the plurality of sub-texts, a text content feature corresponding to a sub-text of the plurality of sub-texts being used to represent content described in the sub-text.

The element dimensions for performing feature extraction on the sub-texts may be preset, so that the text content feature in each sub-text can be obtained. The text content feature is a local feature representing the content described in the sub-text.

In step 14, respectively determining a target feature corresponding to each sub-text of the plurality of sub-texts based on the character feature and a text content feature corresponding to the sub-text.

In step 15, generating a text image corresponding to the sub-text based on the target feature.

In this embodiment, when the text image corresponding to the sub-text is generated, the image is generated based on the text content feature (that is, the local feature corresponding to the sub-text) corresponding to the sub-text and the character feature (that is, the global feature corresponding to the target text). In this way, on one hand, the text image matches the overall content of the target text, and on the other hand, the consistency of images of the same character in different text images can also be ensured.

In step 16, generating a target video corresponding to the target text based on the plurality of sub-texts and text images corresponding to the plurality of sub-texts, respectively.

As an example, a subtitle may be generated based on the sub-text, and the text image and the subtitle may be merged to obtain an image-text material, image-text materials corresponding to the sub-texts may be displayed in a carousel mode according to position sequence information of the sub-texts in the target text, to generate the target video. As another example, a background sound may be matched based on the target text, so that the image-text material and an audio file of the background sound may be further merged to add an audio to the target video.

In this way, in the above technical solution, the character feature is extracted from the target text to obtain the character feature of each character in the target text, so that each character in the target text can be described from a global perspective. Meanwhile, the target text is split into a plurality of sub-texts, and the text content feature respectively corresponding to each of the sub-texts can be determined, so as to obtain the feature corresponding to the local content of each sub-text. Thereafter, the target feature for performing image generation for each sub-text is obtained by combining the character feature and the text content feature of the sub-text, to generate the text image and further obtain the target video. In this way, the image generation can be performed for each sub-text, ensuring the efficiency and accuracy of image generation. Meanwhile, in the process of generating the image for each sub-text, the content of the text image can be constrained by combining with the character feature in the target text, ensuring the consistency of the images of the same character when the images of the same character are generated in different sub-texts, so that the same character remains consistent in the target video, thereby improving the coherence and smoothness of the target video.

In a possible embodiment, an example implementation of the splitting a target text to obtain a plurality of sub-texts corresponding to the target text may include:
determining each sentence in the target text; and
performing text splitting based on sentences in the target text and a storyboard detection model, and using each storyboard text output by the storyboard detection model as the sub-text, each storyboard text comprising at least one sentence, and each sentence belonging to one storyboard text.

As an example, sentence detection may be performed on the target text according to a preset punctuation mark, for example, the preset punctuation mark may be a period, an exclamation mark, etc., which may be set according to an actual application scenario. Thereafter, the sentences in the target text may be input into the storyboard detection model for text splitting. The sentences in the target text may be texts obtained after a sentence identifier is added.

As an example, the storyboard detection model may be obtained through pre-training, and may be implemented by training based on a deep learning model, and may generate a natural language text or understand the meaning of the language text. For example, an NLP language model may be used to complete various language tasks, such as natural language understanding, language generation, text classification, and the like. In the training process of the storyboard detection model, the training text and its corresponding training sub-texts may be obtained, so that the deep learning model can be trained based on the training sub-texts and the training text.

During the process of performing text splitting by the storyboard detection model, a sentence is used as the smallest unit of splitting, so that splitting can be directly performed based on the original text of the target text, ensuring the consistency between the sub-texts and the target text. In addition, splitting is performed based on the storyboards, so that a plurality of sentences corresponding to the same storyboard are divided into the same sub-text, so that there is continuity between the text contents in the same sub-text, and there is discontinuity between the text contents in different sub-texts, thereby ensuring the completeness of the content of each sub-text and providing accurate data support for subsequent image generation.

In a possible embodiment, an example implementation of the performing character feature extraction on the target text to obtain a character feature of each character in the target text may include:
determining each character in the target text and a feature prompt word under each character dimension of at least one character dimension for the character.

The character in the target text and the character feature of the character may be extracted by using a character extraction model. During the feature extraction process, the character dimension in the character feature may be preset according to an actual application scenario, that is, which aspects of features corresponding to the character need to be obtained.

As an example, the at least one character dimension comprises at least one selected from a group comprising a hair dimension, a face dimension, and a clothing dimension, the hair dimension comprises a hairstyle and/or a hair color, and the clothing dimension comprises at least one selected from a group comprising an upper garment, a lower garment, and shoes. For example, for an identified character A, the character feature of the character A may include a hair dimension, a face dimension, and a clothing dimension, for example, the hair dimension may further include a hairstyle and a hair color, for example, a feature prompt word corresponding to the hairstyle may describe the length and shape of the hair, a feature prompt word corresponding to the hair color may describe a specific color, a feature prompt word corresponding to the face dimension may describe features such as a face shape and eyes, and the clothing dimension may further include an upper garment, a lower garment, and shoes. Each of feature prompt words corresponding to the upper garment, the lower garment, and the shoes may respectively describe a corresponding type and a corresponding color. In this way, the feature representation of the character in each dimension may be determined through the above character dimensions, so that the comprehensive representation of the character feature is implemented, and the fineness of the description of the character feature can also be improved, thereby improving the accuracy of character image generation to a certain extent.

Thereafter, the feature prompt words in the character dimensions are merged to obtain the character feature.

As an example, a merging order of the character dimensions may be preset, and the feature prompt words in the character dimensions may be merged in sequence according to the merging order to obtain a prompt word set, which is used as the character feature. For example, the feature prompt words in the dimensions may be added to the prompt word set in sequence according to the order of the hair dimension, the face dimension, and the clothing dimension.

In this way, through the above technical solution, on one hand, the character feature can be described based on the feature prompt word, improving the content matching degree between the character feature and the target text. On the other hand, in the process of character feature extraction, extraction can be performed from a plurality of character dimensions, which ensures the accuracy of feature extraction and can also effectively improve the richness and comprehensiveness of the character feature, thereby achieving the fine description of the character and providing effective support for subsequent image generation.

In a possible embodiment, an example implementation of the determining a plurality of text content features respectively corresponding to the plurality of sub-texts may include:
for each sub-text, determining a target object in the sub-text and a type of the target object based on the sub-text;
determining a prompt word corresponding to each element dimension based on an element dimension corresponding to the type of the target object and the sub-text; and
generating the text content feature corresponding to the sub-text based on the prompt word corresponding to each element dimension.

The above steps may be implemented by using a storyboard extraction task, and the storyboard extraction task may be implemented by using an NLP model. The target object may be used to represent an object that is displayed in a text image corresponding to the sub-text and is predicted based on the sub-text, and the type of the target object may include a person type and a non-person type, and different element dimensions may be preset for different types in advance. For example, the element dimensions corresponding to the person type may include dimensions such as an image subject, a person emotion, a person action, an image background, and the like. The element dimensions corresponding to the non-person type may include an image subject and an image background.

After the target object and the type thereof are determined, feature extraction may be performed based on each element dimension in the type to obtain the prompt word in each element dimension. It should be noted that if there is no feature in a corresponding element dimension in the image, the prompt word in the element dimension may be empty, for example, if it is determined, based on the sub-text, that there is no action, the prompt word under the element dimension of the person action is null, that is, it is not necessary to determine the prompt word from the element dimension.

Similarly, the prompt words corresponding to the element dimensions may be merged according to a merging order of the element dimensions to obtain the text content feature. Dimension prompts of the element dimensions may be retained in the text content feature to further clarify the dimensions corresponding to the prompt words.

In this way, through the above technical solution, when feature extraction is performed on the sub-text, the specific target object and the type thereof can be determined based on the content in the sub-text, and the dimension for performing feature extraction is further determined based on the type, so that the text content feature is accurately extracted, and the feature extraction efficiency can also be improved at the same time, thus avoiding the impact of the extracted invalid feature on the subsequently generated text image and ensuring the accuracy of the text image generation.

In a possible embodiment, the respectively determining a target feature corresponding to each sub-text of the plurality of sub-texts based on the character feature and a text content feature corresponding to the each sub-text comprises:
in response to the text content feature comprising a person feature, determining a target character corresponding to the person feature in the text content feature; and adding, to the text content feature, a character feature corresponding to the target character as a feature of a person description dimension, to obtain the target feature.

Whether the text content feature comprises the person feature is determined based on an image subject in the text content feature, or it may be determined that the text content feature includes the person feature when a prompt word corresponding to a person emotion is not blank. The target character corresponding to the person feature is further determined, where a corresponding character name may be extracted from the person feature, and in this embodiment, the target character corresponding to the person may be determined according to the character name of the person.

If the text content feature includes the person feature, it means that there will be a corresponding person image in the text image generated based on the sub-text. In order to ensure the consistency display of the images of the same person in the sub-texts, the character feature corresponding to the target character corresponding to the person feature may be added as a dimension to the text content feature, which can further improve the diversity and comprehensiveness of the target feature, and can also ensure that the feature description of the same person in different sub-texts is the same, so as to ensure the consistency of the display of the same person in different generated text images and further ensure the coherence when the images in the generated target video are switched.

In a possible embodiment, the generating a target video corresponding to the target text based on the plurality of sub-texts and text images corresponding to the plurality of sub-texts, respectively may include:
generating an audio and a subtitle corresponding to each of the plurality of sub-texts; and then respectively merging audios respectively corresponding to the plurality of sub-texts, subtitles respectively corresponding to the plurality of sub-texts, and the text images based on position sequence information of the plurality of sub-texts in the target text to obtain merged files, and obtaining the target video based on the merged files.

For example, the audio corresponding to the sub-text may be generated based on a speech generation technology, such as TTS (Text-to-Speech), for example, speech generation is separately performed for each sub-text to obtain the audio corresponding to the sub-text.

The subtitle may be generated according to specified text style information, for example, the text style information may include a font, a font size, a color, and the like, so as to generate a corresponding subtitle text.

For example, the audios corresponding to the sub-texts may be merged based on the position sequence information of each of the sub-texts in the target text to obtain an audio file. The subtitles corresponding to the sub-texts are merged based on the position sequence information to obtain a subtitle file. The text images corresponding to the sub-texts are merged based on the position sequence information to obtain a video frame file.

Thereafter, the audio file, the subtitle file, and the video frame file are merged to obtain the target video.

Accordingly, the audio corresponding to the sub-text and the text image corresponding to the sub-text need to maintain a one-to-one correspondence relationship in time sequence. In order to ensure the audio-video synchronization in the video, the text image corresponding to the sub-text needs to be displayed during the playing of the audio corresponding to the sub-text, and the subtitle is correspondingly displayed in the text image. Therefore, when the audio, the subtitle, and the text image are merged in the embodiment, the duration corresponding to the audio of the sub-text may be obtained, and the text image of the sub-text may be converted into a storyboard video frame with the same duration. For example, a display duration corresponding to the text image may be set to convert it into a storyboard video frame having the display duration. For another example, effect processing operations such as adding a picture effect and a transformation effect to the text image may be performed, and when converting, the display duration of the text image including an effect duration after the effect is added may be set as the duration corresponding to the audio of the sub-text, to obtain the storyboard video frame. In this way, the storyboard video frames corresponding to the text images may be obtained. Similarly, the display duration corresponding to the subtitle of each sub-text may be set in a similar manner to ensure the synchronization of the subtitle with the audio and the image.

In this way, the audio file and the video frame file obtained through the above method are aligned in time sequence, so that the audio file, the subtitle file, and the video frame file may be directly merged, which may be merged by using a method of merging audio and an image to obtain a video commonly used in the art to obtain the target video, thereby further ensuring the smoothness of the generated video and the audio-video synchronization during the image playing, and improving the user experience.

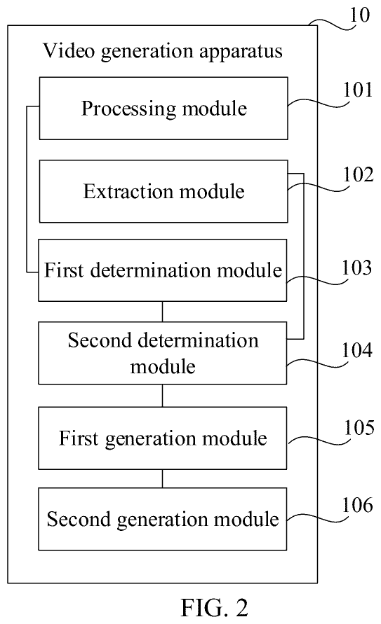

The present disclosure further provides a video generation apparatus. As shown in FIG. 2, the apparatus 10 includes:
a processing module 101 configured to split a target text to obtain a plurality of sub-texts corresponding to the target text;
an extraction module 102 configured to perform character feature extraction on the target text to obtain a character feature of each character in the target text;
a first determination module 103 configured to determine a plurality of text content features respectively corresponding to the plurality of sub-texts, a text content feature corresponding to a sub-text of the plurality of sub-texts being used to represent content described in the sub-text;
a second determination module 104 configured to respectively determine a target feature corresponding to each sub-text of the plurality of sub-texts based on the character feature and a text content feature corresponding to the sub-text;
a first generation module 105 configured to generate a text image corresponding to the sub-text based on the target feature; and
a second generation module 106 configured to generate a target video corresponding to the target text based on the plurality of sub-texts and text images respectively corresponding to the plurality of sub-texts.

For example, the extraction module includes:
a first determination sub-module configured to determine each character in the target text and a feature prompt word under each character dimension of at least one character dimension for the character; and
a first merge sub-module configured to merge at least one feature prompt word under the at least one character dimension to obtain the character feature.

For example, the character dimension comprises at least one selected from a group comprising a hair dimension, a face dimension, and a clothing dimension, the hair dimension comprises a hairstyle and/or a hair color, and the clothing dimension comprises at least one selected from a group comprising an upper garment, a lower garment, and shoes.

For example, the first determination module includes:
a second determination sub-module configured to determine a target object in the sub-text and a type of the target object based on the sub-text;
a third determination sub-module configured to determine a prompt word corresponding to each element dimension based on the element dimension corresponding to the type of the target object and the sub-text; and
a fourth determination sub-module configured to generate the text content feature corresponding to the sub-text based on the prompt word corresponding to each element dimension.

For example, the second determination module includes:
a fifth determination sub-module configured to determine, in response to the text content feature comprising a person feature, a target character corresponding to the person feature in the text content feature; and
an adding sub-module configured to add, to the text content feature, a character feature corresponding to the target character as a feature of a person description dimension to obtain the target feature.

For example, the processing module includes:
a sixth determination sub-module configured to determine each sentence in the target text; and
a processing sub-module configured to perform text splitting based on sentences in the target text and a storyboard detection model, and use each storyboard text output by the storyboard detection model as the sub-text, where each storyboard text comprises at least one sentence, and each sentence belongs to one storyboard text.

For example, the second generation module includes:
a first generation sub-module configured to generate an audio and a subtitle corresponding to each of the plurality of sub-texts; and
a second merge sub-module configured to respectively merge audios respectively corresponding to the plurality of sub-texts, subtitles respectively corresponding to the plurality of sub-texts, and the text images based on position sequence information of the plurality of sub-texts in the target text to obtain merged files, and obtain the target video based on the merged files.

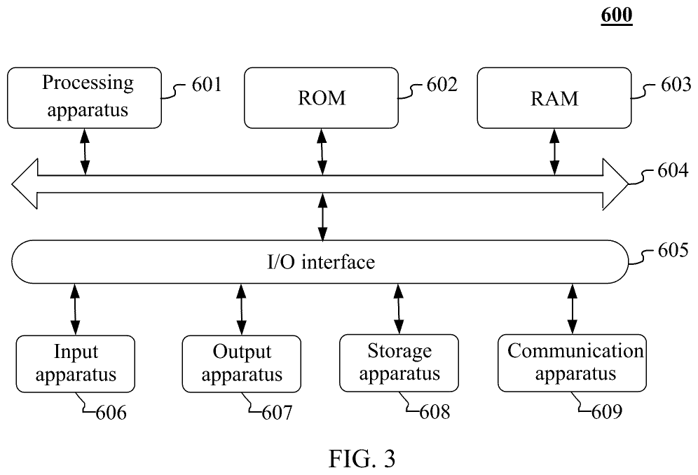

Reference is made to FIG. 3 below, which shows a schematic diagram of a structure of an electronic device (for example, a terminal device or a server) 600 suitable for implementing the embodiments of the present disclosure. The terminal device in the embodiments of the present disclosure may include, but is not limited to, mobile terminals such as a mobile phone, a notebook computer, a digital broadcast receiver, a PDA (Personal Digital Assistant), a PAD (tablet computer), a PMP (Portable Multimedia Player), and a vehicle-mounted terminal (for example, a vehicle navigation terminal), and fixed terminals such as a digital television (TV) and a desktop computer. The electronic device shown in FIG. 3 is merely an example, and should not impose any limitation on the function and scope of use of the embodiments of the present disclosure.

As shown in FIG. 3, the electronic device 600 may include a processing apparatus (such as a central processing unit, and a graphics processor, etc.) 601, which may perform a variety of appropriate actions and processing in accordance with a program stored in a read-only memory (ROM) 602 or a program loaded from a storage apparatus 608 into a random access memory (RAM) 603. The RAM 603 also stores various programs and data required for the operation of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touch screen, a touchpad, a keyboard, a mouse, a camera, a microphone, an accelerometer, and a gyroscope; an output apparatus 607 including, for example, a liquid crystal display (LCD), a speaker, and a vibrator; the storage apparatus 608 including, for example, a magnetic tape and a hard disk; and a communication apparatus 609. The communication apparatus 609 may allow the electronic device 600 to perform wireless or wired communication with other devices to exchange data. Although FIG. 3 shows the electronic device 600 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, the embodiment of the present disclosure includes a computer program product, which includes a computer program carried on a non-transitory computer-readable medium, the computer program includes program codes for performing the method shown in the flowchart. In such an embodiment, the computer program may be downloaded and installed from a network through the communication apparatus 609, or installed from the storage apparatus 608, or installed from the ROM 602. When the computer program is executed by the processing apparatus 601, the above-mentioned functions defined in the method of the embodiment of the present disclosure are executed.

It should be noted that the above computer-readable medium described in the present disclosure may be a computer-readable signal medium, a computer-readable storage medium, or any combination thereof. For example, the computer-readable storage medium may be, but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program, the program may be used by or in combination with an instruction execution system, apparatus, or device. In the present disclosure, the computer-readable signal medium may include a data signal propagated in a baseband or as a part of a carrier, the data signal carries the computer-readable program code. The data signal propagated in this way may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), and the like, or any suitable combination thereof.

In some implementations, the client and the server may communicate by using any currently known or future-developed network protocol such as a HyperText Transfer Protocol (HTTP), and may be connected to digital data communication (for example, a communication network) in any form or medium. Examples of the communication network include a local area network (“LAN”), a wide area network (“WAN”), an internet work (for example, the Internet), an end-to-end network (for example, an ad hoc end-to-end network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: split a target text to obtain a plurality of sub-texts corresponding to the target text; perform character feature extraction on the target text to obtain a character feature of each character in the target text; determine a plurality of text content features respectively corresponding to the plurality of sub-texts, where a text content feature corresponding to a sub-text of the plurality of sub-texts is used to represent content described in the sub-text; respectively determine a target feature corresponding to each sub-text of the plurality of sub-texts based on the character feature and a text content feature corresponding to the each sub-text; generate a text image corresponding to the each sub-text based on the target feature; and generate a target video corresponding to the target text based on the plurality of sub-texts and text images corresponding to the plurality of sub-texts, respectively.

The computer program code for performing the operations in the present disclosure may be written in one or more programming languages or a combination thereof, the above programming languages include but are not limited to an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case involving a remote computer, the remote computer may be connected to the computer of the user by any type of networks, including a local area network (LAN) or a wide area network (WAN), or may be connected to an external computer (for example, connected over the Internet with the aid of an Internet service provider).

The flowcharts and block diagrams in the accompanying drawings illustrate the possibly achieved system architectures, functions, and operations of the system, method, and the computer program product according to various embodiments of the present disclosure. In this regard, each block in the flowchart or block diagram may represent a module, a program segment, or a part of a code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The modules involved in the embodiments described in the present disclosure may be implemented by software or by hardware. The name of a module does not impose any limitation on the module itself in some cases. For example, the processing module may also be described as a “module for splitting a target text to obtain a plurality of sub-texts corresponding to the target text”.

The functions described above in the present disclosure may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system on chip (SOC), a complex programmable logic device (CPLD), and the like.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include but is not limited to electronic, magnetic, optical, electromagnetic, infrared, or semiconductor systems, apparatuses, or devices, or any suitable combination thereof. A more specific example of the machine-readable storage medium may include an electrical connection based on one or more wires, a portable computer disk, a hard disk, a random-access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

According to one or more embodiments of the present disclosure, a video generation method is provided, and the method includes:
splitting a target text to obtain a plurality of sub-texts corresponding to the target text;
performing character feature extraction on the target text to obtain a character feature of each character in the target text;
determining a plurality of text content features respectively corresponding to the plurality of sub-texts, where a text content feature corresponding to a sub-text of the plurality of sub-texts is used to represent content described in the sub-text;
respectively determining a target feature corresponding to each sub-text of the plurality of sub-texts based on the character feature and a text content feature corresponding to the sub-text;
generating a text image corresponding to the sub-text based on the target feature; and
generating a target video corresponding to the target text based on the plurality of sub-texts and text images corresponding to the plurality of sub-texts, respectively.

According to one or more embodiments of the present disclosure, in the method provided above, the performing character feature extraction on the target text to obtain a character feature of each character in the target text includes:
determining each character in the target text and a feature prompt word corresponding to each character dimension for the character; and
merging the feature prompt words corresponding to the character dimensions to obtain the character feature.

According to one or more embodiments of the present disclosure, in the method provided above, the character dimension comprises at least one of a hair dimension, a face dimension, and a clothing dimension, the hair dimension comprises a hairstyle and/or a hair color, and the clothing dimension comprises at least one of an upper garment, a lower garment, and shoes.

According to one or more embodiments of the present disclosure, in the method provided above, the determining a plurality of text content features respectively corresponding to the plurality of sub-texts includes:
for each sub-text, determining a target object in the sub-text and a type of the target object based on the sub-text;
determining a prompt word corresponding to each element dimension based on the element dimension corresponding to the type of the target object and the sub-text; and
generating the text content feature corresponding to the sub-text based on the prompt word corresponding to each element dimension.

According to one or more embodiments of the present disclosure, in the method provided above, the respectively determining a target feature corresponding to each sub-text of the plurality of sub-texts based on the character feature and a text content feature corresponding to the sub-text includes:
in response to the text content feature comprising a person feature, determining a target character corresponding to the person feature in the text content feature; and
adding, to the text content feature, a character feature corresponding to the target character as a feature of a person description dimension, to obtain the target feature.

According to one or more embodiments of the present disclosure, in the method provided above, the splitting a target text to obtain a plurality of sub-texts corresponding to the target text includes:
determining each sentence in the target text; and
performing text splitting based on the sentences in the target text and a storyboard detection model, and using each storyboard text output by the storyboard detection model as the sub-text, where each storyboard text comprises at least one sentence, and each sentence belongs to one storyboard text.

According to one or more embodiments of the present disclosure, in the method provided above, the generating a target video corresponding to the target text based on the plurality of sub-texts and text images corresponding to the plurality of sub-texts, respectively includes:
generating an audio and a subtitle corresponding to each of the plurality of sub-texts; and
respectively merging audios respectively corresponding to the plurality of sub-texts, subtitles respectively corresponding to the plurality of sub-texts, and the text images based on position sequence information of the plurality of sub-texts in the target text to obtain merged files, and obtaining the target video based on the merged files.

According to one or more embodiments of the present disclosure, a video generation apparatus is provided, and the apparatus includes:
a processing module configured to split a target text to obtain a plurality of sub-texts corresponding to the target text;
an extraction module configured to perform character feature extraction on the target text to obtain a character feature of each character in the target text;
a first determination module configured to determine a plurality of text content features respectively corresponding to the plurality of sub-texts, where a text content feature corresponding to a sub-text of the plurality of sub-texts is used to represent content described in the sub-text;
a second determination module configured to respectively determine a target feature corresponding to each sub-text of the plurality of sub-texts based on the character feature and a text content feature corresponding to the sub-text;
a first generation module configured to generate a text image corresponding to the sub-text based on the target feature; and
a second generation module configured to generate a target video corresponding to the target text based on the plurality of sub-texts and text images corresponding to the plurality of sub-texts, respectively.

According to one or more embodiments of the present disclosure, a non-transitory computer-readable medium is provided and a computer program is stored on the non-transitory computer-readable medium, when the computer program is executed by a processor, the steps of the video generation method according to any one embodiment of the present disclosure are implemented.

According to one or more embodiments of the present disclosure, an electronic device is provided and includes:
a memory having a computer program stored thereon; and
a processor configured to execute the computer program in the memory to implement the steps of the video generation method according to any one embodiment of the present disclosure.

The above descriptions are merely some embodiments of the present disclosure and an illustration of the applied technical principles. Persons skilled in the art should understand that the scope of disclosure involved in the present disclosure is not limited to the technical solution formed by the specific combination of the above technical features, and shall also cover other technical solutions formed by any combination of the above technical features or equivalent features thereof without departing from the concept of the present disclosure, for example, a technical solution formed by replacing the above features with technical features with similar functions disclosed in the present disclosure (but not limited thereto).

In addition, although the operations have been described in a specific order, it should not be understood as requiring these operations to be performed in the specific order shown or in sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. On the contrary, various features described in the context of a single embodiment can also be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. On the contrary, the specific features and actions described above are merely exemplary forms for implementing the claims. With respect to the apparatus in the above embodiments, the specific manner in which each module performs an operation has been described in detail in the embodiments related to the method, and will not be described in detail here.

1. A video generation method, comprising:
splitting a target text to obtain a plurality of sub-texts corresponding to the target text;
performing character feature extraction on the target text to obtain a character feature of each character in the target text;
determining a plurality of text content features respectively corresponding to the plurality of sub-texts, wherein a text content feature corresponding to a sub-text of the plurality of sub-texts is used to represent content described in the sub-text;
respectively determining a target feature corresponding to each sub-text of the plurality of sub-texts based on the character feature and a text content feature corresponding to the each sub-text;
generating a text image corresponding to the each sub-text based on the target feature; and
generating a target video corresponding to the target text based on the plurality of sub-texts and text images corresponding to the plurality of sub-texts, respectively.

2. The method according to claim 1, wherein the performing character feature extraction on the target text to obtain a character feature of each character in the target text comprises:
determining each character in the target text and a feature prompt word under each character dimension of at least one character dimension for the character; and
merging at least one feature prompt word under the at least one character dimension to obtain the character feature.

3. The method according to claim 2, wherein the at least one character dimension comprises at least one selected from a group comprising a hair dimension, a face dimension, and a clothing dimension, the hair dimension comprises a hairstyle and/or a hair color, and the clothing dimension comprises at least one selected from a group comprising an upper garment, a lower garment, and shoes.

4. The method according to claim 2, wherein the determining a plurality of text content features respectively corresponding to the plurality of sub-texts comprises:
for each sub-text, determining a target object in the sub-text and a type of the target object based on the sub-text;
determining a prompt word corresponding to each element dimension based on an element dimension corresponding to the type of the target object and the sub-text; and
generating a text content feature corresponding to the sub-text based on the prompt word corresponding to each element dimension.

5. The method according to claim 2, wherein the respectively determining a target feature corresponding to each sub-text of the plurality of sub-texts based on the character feature and a text content feature corresponding to the each sub-text comprises:
in response to the text content feature comprising a person feature, determining a target character corresponding to the person feature in the text content feature; and
adding, to the text content feature, a character feature corresponding to the target character as a feature of a person description dimension, to obtain the target feature.

6. The method according to claim 2, wherein the splitting a target text to obtain a plurality of sub-texts corresponding to the target text comprises:
determining each sentence in the target text; and
performing text splitting based on sentences in the target text and a storyboard detection model, and using each storyboard text output by the storyboard detection model as the sub-text, wherein each storyboard text comprises at least one sentence, and each sentence belongs to one storyboard text.

7. The method according to claim 2, wherein the generating a target video corresponding to the target text based on the plurality of sub-texts and text images corresponding to the plurality of sub-texts, respectively comprises:
generating an audio and a subtitle corresponding to each sub-text of the plurality of sub-texts; and
respectively merging audios respectively corresponding to the plurality of sub-texts, subtitles respectively corresponding to the plurality of sub-texts, and the text images based on position sequence information of the plurality of sub-texts in the target text to obtain merged files, and obtaining the target video based on the merged files.

8. The method according to claim 1, wherein the determining a plurality of text content features respectively corresponding to the plurality of sub-texts comprises:
for each sub-text, determining a target object in the sub-text and a type of the target object based on the sub-text;
determining a prompt word corresponding to each element dimension based on an element dimension corresponding to the type of the target object and the sub-text; and
generating a text content feature corresponding to the sub-text based on the prompt word corresponding to each element dimension.

9. The method according to claim 1, wherein the respectively determining a target feature corresponding to each sub-text of the plurality of sub-texts based on the character feature and a text content feature corresponding to the each sub-text comprises:
in response to the text content feature comprising a person feature, determining a target character corresponding to the person feature in the text content feature; and
adding, to the text content feature, a character feature corresponding to the target character as a feature of a person description dimension, to obtain the target feature.

10. The method according to claim 1, wherein the splitting a target text to obtain a plurality of sub-texts corresponding to the target text comprises:
determining each sentence in the target text; and
performing text splitting based on sentences in the target text and a storyboard detection model, and using each storyboard text output by the storyboard detection model as the sub-text, wherein each storyboard text comprises at least one sentence, and each sentence belongs to one storyboard text.

11. The method according to claim 1, wherein the generating a target video corresponding to the target text based on the plurality of sub-texts and text images corresponding to the plurality of sub-texts, respectively comprises:
generating an audio and a subtitle corresponding to each of the plurality of sub-texts; and
respectively merging audios respectively corresponding to the plurality of sub-texts, subtitles respectively corresponding to the plurality of sub-texts, and the text images based on position sequence information of the plurality of sub-texts in the target text to obtain merged files, and obtaining the target video based on the merged files.

12. A non-transitory computer-readable medium having a computer program stored thereon, wherein when the computer program is executed by a processor, steps of a video generation method are implemented,
wherein the method comprises:
splitting a target text to obtain a plurality of sub-texts corresponding to the target text;
performing character feature extraction on the target text to obtain a character feature of each character in the target text;
determining a plurality of text content features respectively corresponding to the plurality of sub-texts, wherein a text content feature corresponding to a sub-text of the plurality of sub-texts is used to represent content described in the sub-text;
respectively determining a target feature corresponding to each sub-text of the plurality of sub-texts based on the character feature and a text content feature corresponding to the each sub-text;
generating a text image corresponding to the each sub-text based on the target feature; and
generating a target video corresponding to the target text based on the plurality of sub-texts and text images corresponding to the plurality of sub-texts, respectively.

13. The non-transitory computer-readable medium according to claim 12, wherein the performing character feature extraction on the target text to obtain a character feature of each character in the target text comprises:
determining each character in the target text and a feature prompt word under each character dimension of at least one character dimension for the character; and
merging at least one feature prompt word under the at least one character dimension to obtain the character feature.

14. An electronic device, comprising:
a memory, having a computer program stored thereon; and
a processor, configured to execute the computer program in the memory to implement steps of a video generation method,
wherein the method comprises:
splitting a target text to obtain a plurality of sub-texts corresponding to the target text;
performing character feature extraction on the target text to obtain a character feature of each character in the target text;
determining a plurality of text content features respectively corresponding to the plurality of sub-texts, wherein a text content feature corresponding to a sub-text of the plurality of sub-texts is used to represent content described in the sub-text;
respectively determining a target feature corresponding to each sub-text of the plurality of sub-texts based on the character feature and a text content feature corresponding to the each sub-text;
generating a text image corresponding to the each sub-text based on the target feature; and
generating a target video corresponding to the target text based on the plurality of sub-texts and text images corresponding to the plurality of sub-texts, respectively.

15. The electronic device according to claim 14, wherein when perform a step of the performing character feature extraction on the target text to obtain a character feature of each character in the target text, the processor is configured to:
determine each character in the target text and a feature prompt word under each character dimension of at least one character dimension for the character; and
merge at least one feature prompt word under the at least one character dimension to obtain the character feature.

16. The electronic device according to claim 15, wherein the at least one character dimension comprises at least one selected from a group comprising a hair dimension, a face dimension, and a clothing dimension, the hair dimension comprises a hairstyle and/or a hair color, and the clothing dimension comprises at least one selected from a group comprising an upper garment, a lower garment, and shoes.

17. The electronic device according to claim 14, wherein when performing a step of the determining a plurality of text content features respectively corresponding to the plurality of sub-texts, the processor is configured to:
for each sub-text, determine a target object in the sub-text and a type of the target object based on the sub-text;
determine a prompt word corresponding to each element dimension based on an element dimension corresponding to the type of the target object and the sub-text; and
generate a text content feature corresponding to the sub-text based on the prompt word corresponding to each element dimension.

18. The electronic device according to claim 14, wherein when performing a step of the respectively determining a target feature corresponding to each sub-text of the plurality of sub-texts based on the character feature and a text content feature corresponding to the each sub-text, the processor is configured to:
in response to the text content feature comprising a person feature, determine a target character corresponding to the person feature in the text content feature; and
add, to the text content feature, a character feature corresponding to the target character as a feature of a person description dimension, to obtain the target feature.

19. The electronic device according to claim 14, wherein when performing a step of the splitting a target text to obtain a plurality of sub-texts corresponding to the target text, the processor is configured to:
determine each sentence in the target text; and
perform text splitting based on sentences in the target text and a storyboard detection model, and use each storyboard text output by the storyboard detection model as the sub-text, wherein each storyboard text comprises at least one sentence, and each sentence belongs to one storyboard text.

20. The electronic device according to claim 14, wherein when performing a step of the generating a target video corresponding to the target text based on the plurality of sub-texts and text images corresponding to the plurality of sub-texts, respectively, the processor is configured to:
generate an audio and a subtitle corresponding to each of the plurality of sub-texts; and
respectively merge audios respectively corresponding to the plurality of sub-texts, subtitles respectively corresponding to the plurality of sub-texts, and the text images based on position sequence information of the plurality of sub-texts in the target text to obtain merged files, and obtain the target video based on the merged files.
